(19) United States
(12) Patent Application Publication
(10) Pub. No.: US 2008/0216969 A1
(43) Pub. Date: Sep. 11, 2008

(54) Sound absorbing blind systems

(76) Inventors: Arthur P. Barkman, Hillsborough, NJ (US); Michael Kemp, Pittstown, NJ (US)

Correspondence Address: Deirdra M. Meaqher;GlynnTech, Inc., 24 Mine Street, Flemington, NJ, 08822, US

(21) Appl. No.: 12/082,756

(22) Filed: Apr. 14, 2008

Related U.S. Application Data
(63) Continuation-in-part of application No. 11/071,813, filed on Mar. 3, 2005.

(51) Int. Cl. E06B 9/00

(52) U.S. Cl. 160/236

(57) ABSTRACT

The present invention relates to a sound absorbing blind system, which includes: (a) support means for a plurality of window blinds; (b) operational means connected to the support means and to the plurality of window blinds for opening and closing the plurality of window blinds; and, (c) the plurality of window blinds connected to the support means and the operational means, each of the plurality of window blinds being adapted for sound absorption, and each of the plurality of window blinds being an acoustically and insulatively absorptive, unistructural material, having a noise reduction coefficient of at least 0.60 when the plurality of blinds are closed.

### REFERENCE TO RELATED APPLICATION

This is a continuation-in-part of copending U.S. patent application Ser. No. 11/071,813 filed on Mar. 3, 2005, entitled “Sound Absorbing Composite Blind Systems” by the same inventors herein.

### BACKGROUND OF THE INVENTION

1. Field of the Invention

The present invention relates to window blinds, doorway blinds, divider blinds and other blinds that are opened and closed to permit/prevent light entry and/or create/remove privacy. More specifically, the present invention relates to blind systems of the above types wherein these blinds systems advantageously absorb sound to decrease echoing, reverberations, distortion, etc. in the surrounding environments.

2. Information Disclosure Statement

The following patents represent the prior art pertaining to various blind systems.

U.S. Pat. No. 4,276,954 to Paul L. Romano describes an adjustable light and air-admitting thermal and acoustic barrier that has a plurality of sound-attenuating blades pivotally mounted in a frame in a mutually spaced, parallel relationship. When the barrier is mounted at an open window, the blades may be adjusted to various open positions to allow desired amounts of outside light and air into a room, but cooperate in such open positions to form an effective sound trap for annoying outside sounds. Each of the blades functions as both a sound absorber and a sound transmission barrier, and comprises an elongated, relatively thin core of solid, sound-reflective material having longitudinally extending edge and intermediate flanges which define cavities on opposite sides of the core. Secured within the cavities by the flanges are strips of sound-absorbing insulating material, the core and insulating material being laterally enfolded by a cover secured to the flanges. When the blades are in their fully closed position, they form a thermal barrier to reduce heat gain or loss through the window.

U.S. Pat. No. 4,773,958 to Barry I. Goodman describes laminates which are comprised of strand material that is not free hanging and in which there are substantial spaces between the strands to allow light to pass through the material, and a sheet-like layer to which the strand material is secured so that the strands of the laminate are fixed. The laminates allow the color of the characteristics of a slat member or insert to be seen. The laminates can have differing surface characteristics, (e.g. texture) and strand colors, sizes and patterns. The sheet-like layer can be transparent or translucent. A laminate can be secured directly, for example by adhesive, to a slat member having light-transmitting properties (e.g. opaque or translucent), surface characteristics (e.g. texture), and/or color which affect the overall appearance of the slat. A laminate can be removably secured to a groover slat member which can have light-transmitting properties, surface characteristics and/or color which affect the overall appearance of the slat. An insert can be disposed between the laminate and the groover slat which itself has light-transmitting properties (e.g. opaque, translucent), surface characteristics and/or color or print which affect the overall appearance of the slat. The laminate allows the insert and/or slat member to be seen, to provide color, etc. to the slat assembly. The laminates allow a vertical blind slat to be assembled easily from a particular laminate and slat member, and insert if used. By stocking a limited number of laminates, slat members and inserts, a wide variety of slat assemblies can be provided. The laminates can have a plastic or fabric second layer to which the strand material is secured.

U.S. Pat. No. 4,884,615 to Henry C. Hsu describes a slat for use in the assembly of a Venetian blind that is provided with a light and sound absorptive coating on at least one if its major surfaces produced by flecking, applique, or textile weaving techniques, a preferred embodiment of the invention providing a strip having enhanced resistance to slippage of a coating appliqued to the strip and of a textile encapsulation of the strip in directions laterally and longitudinally of the strip.

U.S. Pat. No. 6,446,751 to Krishan K. Ahuja et al. describes a flexible sound shielding curtain that contains a plurality of sound insulating sheet inserts encased within pockets or otherwise secured on the exterior surfaces of the panels of a curtain. The sound insulating sheet inserts may be constructed of a combination of materials selected and configured such that sound impinging upon the curtain is absorbed or alternatively reflected. The sound shielding curtain can be tuned to insulate an area from a select range of frequencies inherent in select environments. Turning may be accomplished through the selection and installation of sound insulating sheet inserts configured to reflect or absorb audible acoustical energy. The sound insulating sheet inserts are readily removable to permit periodic laundering of the curtain fabric and to provide adaptability for a number of applications. Sound shielding curtain(s) can be selected, configured, installed, and extended in such a manner as to provide sound reduction in a localized space. The sound shielding curtain(s) may also be configured with a view window by replacing a portion of one or more sound insulating sheets with an acoustically hard transparent material. The acoustically hard material may also comprise a panel of controllable privacy film.

U.S. Pat. No. 6,497,266 B1 to Roger Palmer et al. describes a window covering that includes a plurality of slats, each slat including a slat base derived from a felt batt and, in one preferred embodiment, a fabric layer. The slat base is thermally treated to form a polymer matrix and can be molded into any desired shape. The starting felt batt includes at least two types of thermoplastic fibers, one having a lower melting point than the other. The thermal forming includes heating the felt batt to a temperature sufficient to melt the lower melting fibers to form a polymer matrix which at least partially envelopes the fibers of the higher melting component. A method of fabricating a slat for a window covering is also disclosed. In its most basic form the method includes the steps of thermally forming the slat base and molding it into the desired shape. The optional step of securing a layer of fabric to the slat is also disclosed.

U.S. Pat. No. 6,598,650 B1 to Roger C. Palmer describes a rigid hollow vane for door or window coverings that includes a vane shell and an optional fabric covering. The shell is thermally formed and results in a polymer matrix at least partially enveloping the fibers. In its most preferred form, the polymer matrix results from heating a batt of two types of fibers, the one type having a lower melting point than the remaining fibers, so that a rigid polymer matrix can be formed about other fibers in the batt.

U.S. Pat. No. 6,615,951 to Claude Boutin et al. describes an invention that concerns an absorbent material consisting of a porous matter with open porosity characterized in that in comprises a plurality of perforations with varied transverse cross-section end positioned at an angle relative to a specific dimension of the material, thereby providing additional porosity to the material.

United States Patent Application Publication No. 2006/0113046 A1 describes a window covering component comprising a substrate having a modulus of elasticity and a stiffener having a higher modulus of elasticity than the substrate and a positioned substantially away from the plane in which the substrate would otherwise tend to deform.

Notwithstanding the prior art, the present invention is neither taught nor rendered obvious thereby.

### SUMMARY OF THE INVENTION

The present invention relates to a sound absorbing blind system, which comprises: (a) support means for a plurality of window blinds; (b) operational means connected to the support means and to the plurality of window blinds for opening and closing the plurality of window blinds; and, (c) the plurality of window blinds connected to the support means and the operational means, each of the plurality of window blinds being adapted for sound absorption, and each of the plurality of window blinds being an acoustically and insulatively absorptive, unistructural material, having a noise reduction coefficient of at least 0.60 when the plurality of blinds are closed.

The support means may be any blind support means, such as inside and outside vertical cords with horizontal connectors passed through cut outs in the blinds so that relative movement of the inside vertical cord to the outside vertical cord causes angle change of the connectors, thereby opening or closing the blinds. These cords act to support or hang the blinds as well as act as a portion of the operational means. Typically these vertical cords or lines suspend from a top, rigid housing with one of more hanging rods or ropes for blind adjustment. These are typical residential blind fittages. Alternatively, connecting tapes may be used to connect the blinds and support them or enclosure channels may be used to clamp onto or otherwise connect with the blinds and housings or fittages for opening and closing. As a fourth alternative, the blinds may have cut ends with pins or rods inserted for connection to operational housings. In fact, any known blind support means and operational means may be used.

In some embodiments of the present invention sound absorbing blind system, the plurality of window blinds material is a fiber glass layer selected from the group consisting of compression molded fiber glass, spun fiber glass and swirled mat fiber glass.

In some embodiments of the present invention sound absorbing blind system, the plurality of window blinds material is a foam material.

In some embodiments of the present invention sound absorbing blind system, the foam material is selected from the group consisting of at least partially open pore urethane foam and at least partially open pore polyester foam.

In some embodiments of the present invention sound absorbing blind system, the plurality of window blinds material is a mat material selected from the group consisting of inorganic mat, organic mat and combinations thereof.

In some embodiments of the present invention sound absorbing blind system, there are at least two diverse layers to the plurality of window blinds material that are both acoustically and insulatively absorptive and together as a unistructure.

In some embodiments of the present invention sound absorbing blind system, at least one of the two diverse layers is a fiber glass layer selected from the group consisting of compression molded fiber glass, spun fiber glass and swirled mat fiber glass.

In some embodiments of the present invention sound absorbing blind system, at least one of the two diverse layers is a foam layer.

In some embodiments of the present invention sound absorbing blind system, the foam layer is selected from the group consisting of at least partially open pore urethane foam and at least partially open polyester foam.

In some embodiments of the present invention sound absorbing blind system, at least one of the two diverse layers is a mat layer selected from the group consisting of inorganic mat, organic mat and combinations thereof.

In some embodiments of the present invention sound absorbing blind system, each blind of the plurality of blinds includes two opposing elongated enclosure channels that receive and hold peripheral edges of the blind.

In some embodiments of the present invention sound absorbing blind system, the elongated enclosure channels are channels having cross-sections selected from the group consisting of three right angled sides and arcuated.

In some embodiments of the present invention sound absorbing blind system, each blind of the plurality of window blinds has a thickness of about 0.15 inches to about 0.5 inches.

In some embodiments of the present invention sound absorbing blind system, the plurality of window blinds material has a density of about 4 pounds per cubic foot to about 9 pounds per cubic foot.

In some embodiments of the present invention sound absorbing blind system, the plurality of blinds are vertical blinds.

In some embodiments of the present invention sound absorbing blind system, the plurality of blinds are horizontal blinds.

In some embodiments of the present invention sound absorbing blind system, the blinds are angled blinds.

In some embodiments of the present invention sound absorbing blind system, the plurality of blinds are vertical blinds.

In some embodiments of the present invention sound absorbing blind system, the plurality of blinds are horizontal blinds.

In some embodiments of the present invention sound absorbing blind system, the blinds are angled blinds.

### BRIEF DESCRIPTION OF THE DRAWINGS

The present invention should be more fully understood when the specification herein is taken in conjunction with the drawings appended hereto wherein:

FIG. 1 shows a partial cut, front view of one embodiment of a present invention sound absorbing blind system;

FIG. 2 shows a top cut view of one preferred blind used in a present invention sound absorbing blind system;

FIGS. 3 and 4 show top cut and top cut partial views, respectively, of various present invention sound absorbing blinds;

FIGS. 5 and 6 show front views of alternative embodiments of present invention sound absorbing blind systems;

FIGS. 7 and 8 show graphic test results for noise reduction coefficients of a present invention sound absorbing blind system; and,

FIG. 9 illustrates another preferred embodiment present invention sound absorbing blind.

### DETAILED DESCRIPTION OF THE PRESENT INVENTION

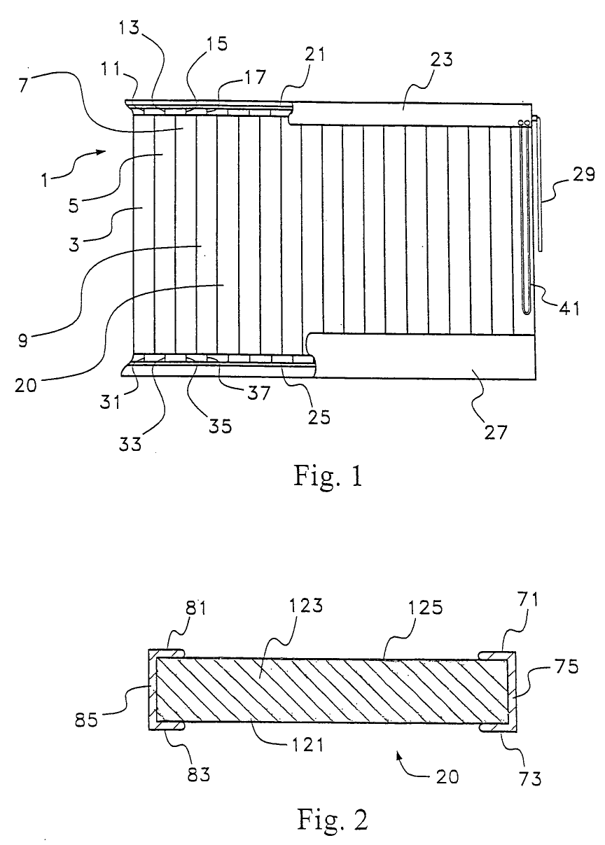

FIG. 1 shows a partial cut, front view of a present invention sound absorbing blind system 1. It includes a plurality of individual vertical blinds, e.g., 3, 5, 7, 9 and 20. These blinds are mounted in a frame that has a horizontal top housing 23 and an optional horizontal bottom housing 27, with tracks 21 and 25, respectively. Each blind has an upper fittage that comprises a vertical attachment connected to a track support that may be slid left to right and right to left on the tracks and may be rotated. These may be any of a number of known system supports used with conventional vertical blinds the details of which are within the purview of the artisan. Thus blinds 3, 5, 7 and 9, for example, have upper vertical attachment fittage 11, 13, 15 and 17 respectively, and optional lower vertical attachment fittages 31, 33, 35 and 37, respectively. A user would rotate rod 29 to rotate the blinds by these fittages for stationary (fixed axis) opening and closing, and would pull on the one side or the other of cord 41 to slide open and to slide close these blinds along the track (linear movement).

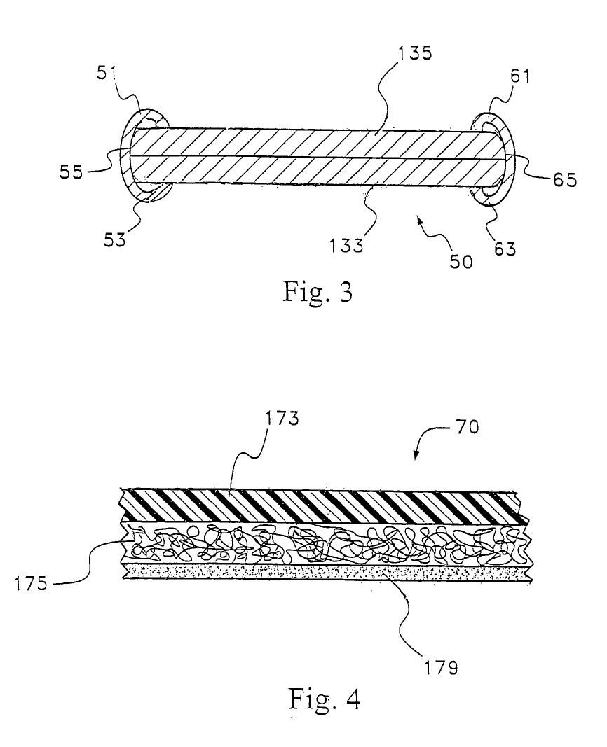

FIG. 2 shows a top cut view of one preferred blind used in a present invention sound absorbing blind system 1 shown in FIG. 1. FIG. 2 thus shows slide 20 from system 1 in FIG. 1, in a top cut view. There is one layer of material 123 cut in elongated rectangular shape, and having a front 121 and a back 125. The material is acoustically and insulatively absorptive, as well as being unistructural. Furthermore, the material 123 has a noise reduction coefficient of at least 0.60 when the plurality of blinds are closed. In this embodiment, the material 123 is a compression molded mat of glass fibers with phenolic resins (e.g. phenol formaldehyde) commonly know as fiber glass. This material has a density of about 5 pounds per cubic foot to about 9 pounds per cubic foot. Other materials, such as spun fiber glass and swirled mat fiber glass, may be substituted for the mat. The material 123 is usually semi-flexible but may stand on its own like a foam or cardboard, such as partially open pore urethane foam and at least partially open pore polyester foam. Furthermore, the material 123 may be a mat including inorganic mat, organic mat and combinations thereof.

The material 123 is supported by a frame in the form of side and top and bottom enclosure channels. In this FIG. 2, the enclosure channels 75 and 85 are shown and these have right angled ends 71 and 73, and 81 and 83, respectively, to hold the material in place.

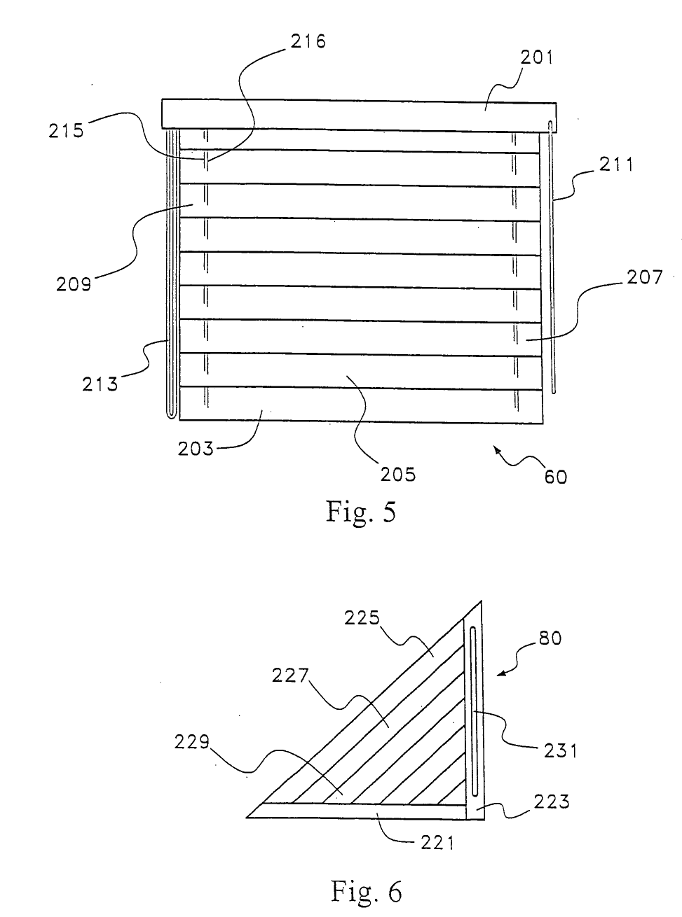

FIGS. 3 and 4 show top cut and top cut partial views respectively, of various alternative present invention sound absorbing blinds.

FIG. 3 shows a top cut view of present invention blind 50. It has at least two diverse layers 133 and 135 of material, diverse layer 133 being a partially open pore polyurethane semi-flexible foam, and diverse layer 135 being a felt mat. The at least two diverse layers 133 and 135 are both acoustically and insulatively absorptive and together are a unistructure. The material selections for the at least two diverse layers 133 and 135 are the same as described by FIG. 2 above.

FIG. 4 shows present invention blind 70 with three diverse layers 173, 175 and 179 of material. Diverse layer 173 is a semi-porous polyester foam while diverse layer 175 is a spun glass fiber mat. The at least two diverse layers 173, 175 and 179 are all acoustically and insulatively absorptive and together are a unistructure. The material selections for the at least two diverse layers 173, 175 and 179 are the same as described by FIG. 2 above.

All of the blinds shown and described in the Figures above have a noise reduction coefficient of over 0.65. (Noise reduction coefficient is the average of the coefficients measured at 250, 500, 1000 and 2000 Hz.)

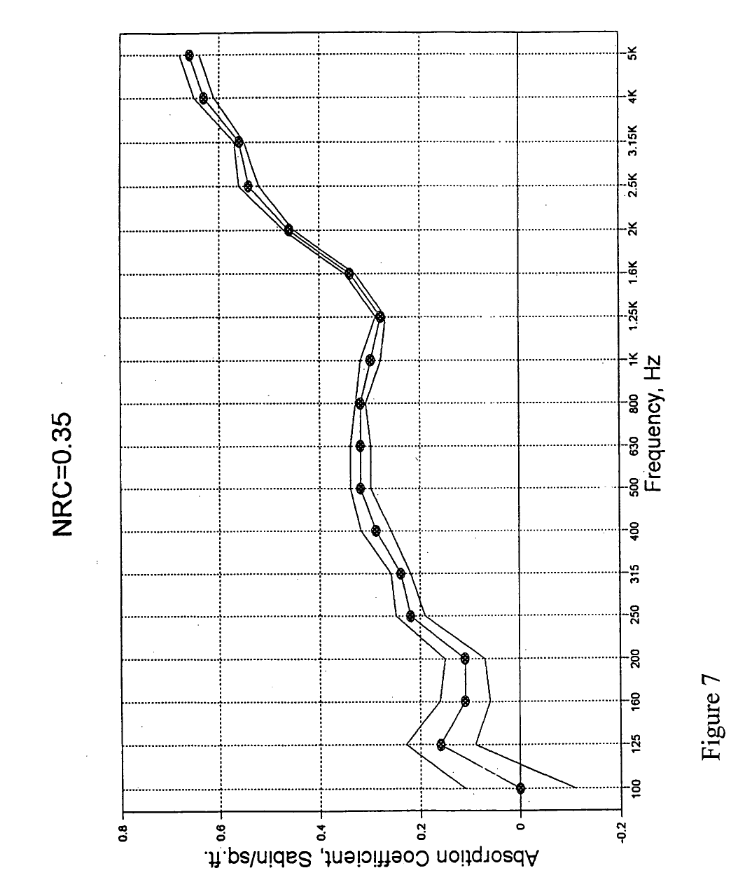

FIGS. 5 and 6 show front views of alternative present invention sound absorbing blind systems. FIG. 5 shows a horizontal blind system 60 with horizontal blinds 203, 205, 207, 209, etc. There is an optional top housing 201 (and no bottom housing) with connecting lines such as lines 215 and 216 that connect inside housing 201 to permit opening and closing and raising and lowering of the blinds. The cord 213 is used for raising and lowering, and the rod 211 is twisted for opening and closing the blinds on a fixed axis. The blinds themselves are of the type shown in FIG. 3.

FIG. 6 shows present invention blind system 8—for a right triangle window. These do not slide but only rotate. The blinds 225, 227, 229, etc. have connections inside horizontal housing 221 and vertical housing 231 and are rotated in plane to open and close, by rotation of rod 231. These blinds have a construction as shown in FIG. 4.

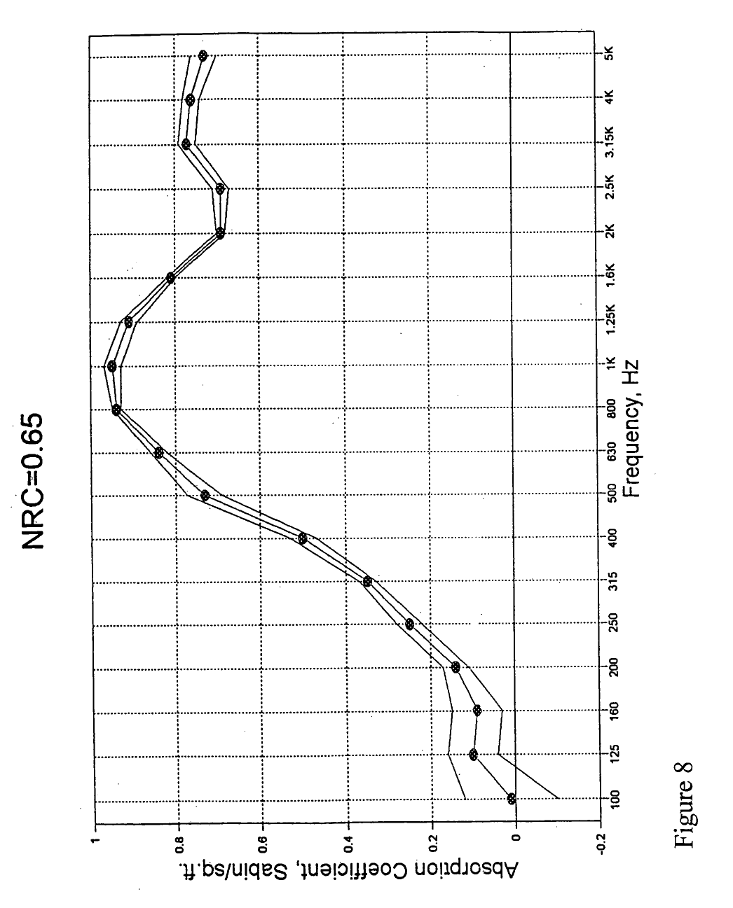

FIGS. 7 and 8 show graphic test results for noise reduction coefficients of a present invention sound absorbing blind system shown in FIGS. 1 and 2. These test were conducted on a window with measurements from inside a room.

The sound adsorption coefficient of a surface in a specified frequency band is, aside from the effects of diffraction, the fraction of randomly incident sound energy absorbed or otherwise not reflected. The unit of measurement is Sabin per square foot.

The noise reduction coefficient, NRC, is the average of the sound absorption coefficients at 250, 500, 1000 and 2000 Hz expressed to the nearest integral multiple of 0.05. Measurements were made according to: ASTM Designation: C 423-90 g, “Standard Test Method for Sound Absorption and Sound Absorption Coefficients by the Reverberation Room Method.” Standard Mountings are defined in: ASTM Designation: E 795-91, “Standard Practices for Mounting Test Specimens During Sound Absorption Test.”

The test specimen consisted of 48 vertical blind strips. Each strip was 3¾″ wide by 71¾″ long by ¼″ thick. The strips were mounted in channels as described above. The mounting fixture consisted of three wooden frames enclosed on four sides. Each frame's inside dimensions were 48″ by 72″. The three frames were placed against the test room wall adjacent each other, forming a continuous test specimen 6′ high and 12′ wide. The vertical blind strips were hung on 3″ centers from cup hooks screwed into the top of each wooden frame. The line along which the cup hooks were secured was 2⅝″ from the test wall surface. The cracks between the top rear edges of the wooden frames and the test surface was sealed with duct tape to prevent sound from entering from the top. The blind strips were positioned in the open configuration, at a 90° angle from the test surface, and subsequently in the fully closed position.

The specimen, identified as “Vertical Blind Strips” was submitted for testing by Arthur Barkman. The weight of the specimen was 23.5 pounds. The area used to calculate absorption coefficients was 72 square feet, the face area of the specimen.

The calculated values of the sound absorption of the specimen and sound absorption coefficients together with the calculated measurement uncertainty for each are tabulated in Tables 1 and 2 below for open and closed blinds, respectively. FIGS. 7 and 8 show the results graphically for open and closed blinds. Point dots are data points and upper and lower lines on these graphs are deviation lines. Results were more than double the NRC of standard blinds.

TABLE 1
PRESENT INVENTION BLINDS OPEN

| Frequency | Absorption | | Coefficient | |
|---|---|---|---|---|
| (Hz) | (Sabin) | Deviation | (Sabin/ft²) | Deviation |
| 100 | 0 | 8.1 | 0 | 0.11 |
| 126 | 11.4 | 4.7 | 0.16 | 0.07 |
| 160 | 7.9 | 3.8 | 0.11 | 0.05 |
| 200 | 7.6 | 2.6 | 0.11 | 0.04 |
| 250 | 15.6 | 2.5 | 0.22 | 0.03 |
| 315 | 17.2 | 1.7 | 0.24 | 0.02 |
| 400 | 21.2 | 2.2 | 0.29 | 0.03 |
| 500 | 22.9 | 1.5 | 0.32 | 0.02 |
| 630 | 22.9 | 1.3 | 0.32 | 0.02 |
| 800 | 23.2 | 1 | 0.32 | 0.01 |
| 1K | 21.3 | 1.2 | 0.3 | 0.02 |
| 1.25K | 20.2 | 1 | 0.28 | 0.01 |
| 1.6K | 24.0 | 0.7 | 0.34 | 0.01 |
| 2K | 32.9 | 0.7 | 0.46 | 0.01 |
| 2.5K | 38.6 | 1.3 | 0.54 | 0.02 |
| 3.15K | 40.3 | 1.1 | 0.56 | 0.01 |
| 4K | 45.5 | 1.7 | 0.63 | 0.02 |
| 5K | 47.8 | 1.7 | 0.66 | 0.02 |

| | |
|---|---|
| Noise Reduction Coefficient (NRC) | 0.35 |

TABLE 2
PRESENT INVENTION BLINDS CLOSED

| Frequency | Absorption | | Coefficient | |
|---|---|---|---|---|
| (Hz) | (Sabin) | Deviation | (Sabin/ft²) | Deviation |
| 100 | 0.7 | 8.2 | 0.01 | 0.11 |
| 126 | 6.9 | 4.6 | 0.1 | 0.06 |
| 160 | 6.6 | 4.2 | 0.09 | 0.06 |
| 200 | 10.1 | 2.2 | 0.14 | 0.03 |
| 250 | 17.9 | 2 | 0.25 | 0.03 |
| 315 | 25.3 | 1.5 | 0.35 | 0.02 |
| 400 | 36.3 | 1.9 | 0.5 | 0.03 |
| 500 | 52.3 | 2.6 | 0.73 | 0.04 |
| 630 | 60.7 | 1.2 | 0.84 | 0.02 |
| 800 | 67.9 | 1.1 | 0.94 | 0.01 |
| 1K | 68.5 | 1.3 | 0.95 | 0.02 |
| 1.25K | 65.8 | 1.3 | 0.91 | 0.02 |
| 1.6K | 58.1 | 1 | 0.81 | 0.01 |
| 2K | 49.9 | 1 | 0.69 | 0.01 |
| 2.5K | 49.6 | 1.2 | 0.69 | 0.02 |
| 3.15K | 55.4 | 1.3 | 0.77 | 0.02 |
| 4K | 55.4 | 1.3 | 0.76 | 0.02 |
| 5K | 52.8 | 2.2 | 0.73 | 0.03 |

| | |
|---|---|
| Noise Reduction Coefficient (NRC) | 0.65 |

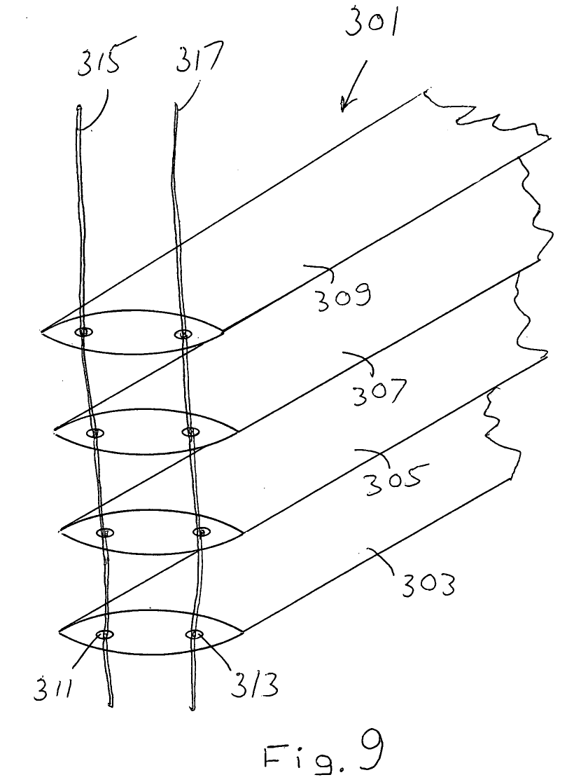

FIG. 9 illustrates a partial oblique view of another alternative preferred embodiment present invention sound absorbing blind system 301. System 301 includes a plurality of blinds 303, 305, 307 and 309. Each of these blinds in unistructureally formed in any manor described above and has a homogenous color throughout. This is achieved by including a dye in the casting or extrusion materials to create a consistent color throughout. This will enable a manufacturer to custom cut blind lengths while maintaining the consistent color on exposed end portions. Further, each of blinds 303, 305, 307 and 309 have receiving orifices such as orifices 311 and 313 for receiving pins connected to rods or cords such as cords 315 and 317. The rods or cords will be connected to functional fittages (not shown) at the top with adjustment rods or cords that will enable a user to open or close up and down as well as open or close by rotation.

The present invention blind systems offer the user/designer the opportunity to create arrangements with a selection of materials of construction, shapes and sizes, and eliminate the need for rigid extruded plastic or metal blinds or blind substrates previously used, while providing increased sound absorption. The later advantageous present invention characteristic will be beneficial to both decrease sound reflection and decrease sound distortion, as has historically occurred in meetings, videoconferencing, teleconferencing and other interior space. Prior to the use of the present invention systems, the largest source of untreatable sound reverberation and distortion (through additive and canceling effects of original and echoing sound waves) in meeting rooms and conferencing rooms has been window areas, including conventional window areas, even with conventional blinds closed! These problems have been significantly reduced with the present invention blind systems.

While appearing the same as traditional blinds, the present invention blinds provide for absorption of 65% of incident noise (over 85% in the articulate speech frequency range) when closed and 35% absorption (over 40% in the articulate speech frequency range) when open.

Obviously, numerous modifications and variations of the present invention are possible in light of the above teachings. It is therefore understood that within the scope of the appended claims, the invention may be practiced otherwise than as specifically described herein.

What is claimed is:

1. A sound absorbing blind system, which comprises:
(a) support means for a plurality of window blinds;
(b) operational means connected to said support means and to said plurality of window blinds for opening and closing said plurality of window blinds; and,
(c) said plurality of window blinds connected to said support means and said operational means, each of said plurality of window blinds being adapted for sound absorption, and each of said plurality of window blinds being an acoustically and insulatively absorptive, unistructural material, having a noise reduction coefficient of at least 0.60 when said plurality of blinds are closed.

2. The sound absorbing blind system of claim 1 wherein said plurality of window blinds material is a fiber glass layer selected from the group consisting of compression molded fiber glass, spun fiber glass and swirled mat fiber glass.

3. The sound absorbing blind system of claim 1 said plurality of window blinds material is a foam material.

4. The sound absorbing blind system of claim 3 wherein said foam material is selected from the group consisting of at least partially open pore urethane foam and at least partially open pore polyester foam.

5. The sound absorbing blind system of claim 1 wherein said plurality of window blinds material is a mat material selected from the group consisting of inorganic mat, organic mat and combinations thereof.

6. The sound absorbing blind system of claim 1 wherein there are at least two diverse layers to said plurality of window blinds material that are both acoustically and insulatively absorptive and together as a unistructure.

7. The sound absorbing blind system of claim 6 wherein at least one of said two diverse layers is a fiber glass layer selected from the group consisting of compression molded fiber glass, spun fiber glass and swirled mat fiber glass.

8. The sound absorbing blind system of claim 6 wherein at least one of said two diverse layers is a foam layer.

9. The sound absorbing blind system of claim 8 wherein said foam layer is selected from the group consisting of at least partially open pore urethane foam and at least partially open polyester foam.

10. The sound absorbing blind system of claim 6 wherein at least one of said two diverse layers is a mat layer selected from the group consisting of inorganic mat, organic mat and combinations thereof.

11. The sound absorbing blind system of claim 1 wherein each blind of said plurality of blinds includes two opposing elongated enclosure channels that receive and hold peripheral edges of said blind.

12. The sound absorbing blind system of claim 11 wherein said elongated enclosure channels are channels having cross-sections selected from the group consisting of three right angled sides and arcuated.

13. The sound absorbing blind system of claim 1 wherein each blind of said plurality of window blinds has a thickness of about 0.15 inches to about 0.5 inches.

14. The sound absorbing blind system of claim 1 wherein said plurality of window blinds material has a density of about 4 pounds per cubic foot to about 9 pounds per cubic foot.

15. The sound absorbing blind system of claim 1 wherein said plurality of blinds are vertical blinds.

16. The sound absorbing blind system of claim 1 wherein said plurality of blinds are horizontal blinds.

17. The sound absorbing blind system of claim 1 wherein said blinds are angled blinds.

18. The sound absorbing blind system of claim 6 wherein said plurality of blinds are vertical blinds.

19. The sound absorbing blind system of claim 6 wherein said plurality of blinds are horizontal blinds.

20. The sound absorbing blind system of claim 6 wherein said blinds are angled blinds.
